(19) United States
(12) Patent Application Publication
(10) Pub. No.: US 2002/0109997 A1
(43) Pub. Date: Aug. 15, 2002

(54) Structure for separable lamp cover

(76) Inventor: Wen-Chang Wu, Chang Hua Hsien (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/782,019

(22) Filed: Feb. 14, 2001

(51) Int. Cl. F21V 1/16

(52) U.S. Cl. 362/450; 362/357

(57) ABSTRACT

The invention, a kind of improved structure for separable lamp covers, mainly comprises of a top ring on the very top of the lamp cover, a bottom ring equipping an opening on the appropriate location, and a support frame connecting the top ring and the bottom ring. Near the support portion of a support frame, there are support bars extending radiantly from the top ring and equipping clip hooks. After the assembly of the support frame, the upper transversal arch bars exactly hit the bottom rim of the clip hooks. The bottom of the support frame is directly punched to form clip elements with piercing holes. The clip elements can exactly be inserted from the opening on the bottom ring onto the bottom ring. Also, on both sides of the support frame, the bottom ring equips punched convex stoppers to constrain the movement of the support frame. Finally, weld the opening on the bottom ring. During assembly, one may rotate the support frame to reach horizontal state. The lamp cover can thus be assembled with minimum volume to achieve the objectives of easy assembly and to reduce storage volume and delivery cost.

### BACKGROUND OF THE INVENTION

1) Field of the Invention

The invention is related to a kind of improved structure for separable lamp covers. Near the ends of support bars, the top ring is bent upward to form clip hooks for the fixture of the ring rim. The upper transversal arch bars on the support frame exactly hit the bottom rim of clip hooks on the top ring to constrain the movement of the support frame. The bottom of the support frame is punched to form clip elements with piercing holes, which exactly pass the bottom ring. On the bottom ring, there are punched flat convex stoppers on both sides of the support frame to constrain the movement of the support frame. The lamp cover can thus be assembled with minimum volume to achieve the objectives of easy assembly and to reduce storage volume and delivery cost.

2) Description of the Prior Art

Please refer FIG. 5, the traditional lamp cover 5. Most of the support frames directly connect the top ring and the bottom ring to form lamp cover structure. However, due to the structural drawbacks, there are many practical defectives for this kind of lamp cover structure. Further improvement and development are needed. The defectives are further described as follows:

The prior lamp covers form certain structural shape, therefore, the lamp covers can not be compressed during delivery and the products take too much space. The storage and delivery volume for this kind of product can not be reduced, hence the delivery cost is raised. It leads to cost increase.

On the basis of thorough research for constant improvement, the inventor finally developed the invention, a kind of lamp cover for easy assembly and great improvement in practical usage.

### SUMMARY OF THE INVENTION

The primary objective of the invention is to provide a kind of improved structure for separable lamp covers, which mainly comprises of a top ring, a bottom ring, and a support frame. Near the support portion of the support frame, the top ring extrudes radiantly to form support bars with clip hooks. After the assembly of the support frame, the upper transversal arch bars on the support frame hit exactly the bottom rim of the clip hooks. The bottom of the support frame is punched to form clip elements with piercing holes, which exactly pass the bottom ring. On the bottom ring, there are punched flat convex stoppers on both sides of the support frame to constrain the movement of the support frame. On the bottom ring, there are punched flat convex stoppers on both sides of the support frame to constrain the movement of the support frame. Finally, the support frame joins the bottom ring. During assembly, one may rotate the support frame to reach horizontal state. The lamp cover can thus be assembled with minimum volume to achieve the objectives of easy assembly and to reduce storage volume and delivery cost.

The followings are brief description and legend for optimal embodiments of the invention for committee's better understanding in the structural characteristics and operations of the invention.

### BRIEF DESCRIPTION OF THE DRAWINGS

FIG. 1 is an exploded drawing of the invention.

FIG. 2 is an isometric assembly drawing of the invention.

FIG. 2A is an enlarged planar drawing of the bottom ring and the support portion on the support frame.

FIG. 3 is a folded and unfolded drawing of an embodiment for the invention.

FIG. 4 is a planar drawing of the installation of lamp cover cloth for the invention.

FIG. 4A is an enlarged planar drawing of the adhesion portion for the invention.

FIG. 5 is an isometric drawing of the prior product.

### DETAILED DESCRIPTION OF THE PREFERRED EMBODIMENT

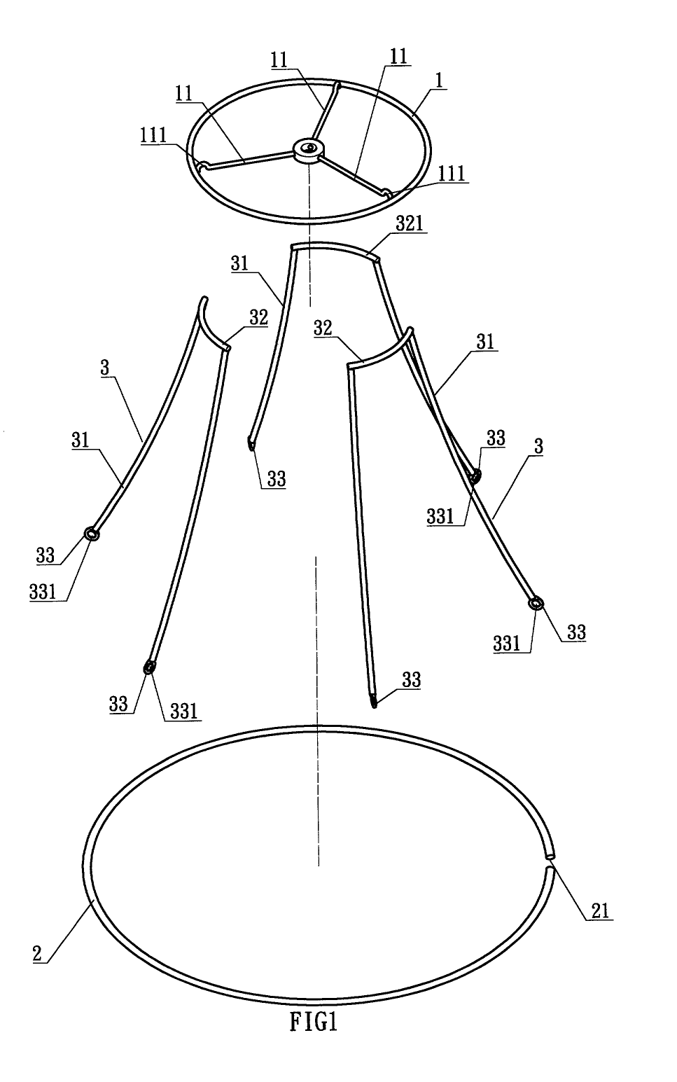

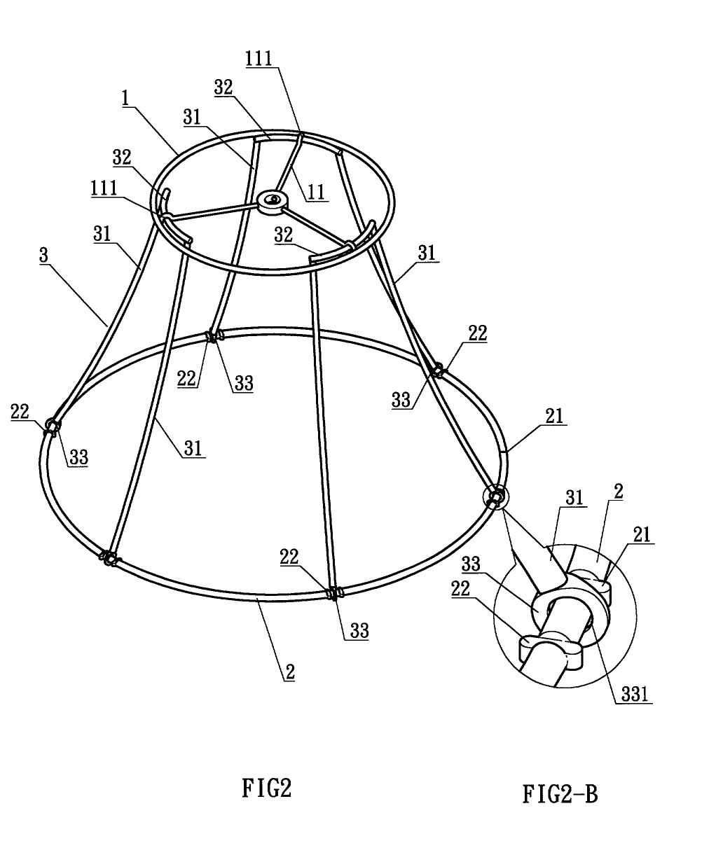

Please refer FIG. 1 and 2 for the structure of the invention, comprising of a top ring 1 on the very top of a lamp cover, a bottom ring 2, of which the perimeter is greater than that of the top ring, and a support frame 3 connecting the top ring 1 and the bottom ring 2.

The top ring 1 made of metal is in round-cylinder structure and exactly hits the stand bar of a table lamp. The top ring 1 extrudes radiantly to form support bars 11. The end of the bars are bent upward as clip hooks 111, which fix the rim of the top ring to connect and interlock the support frame 3.

On the proper locations of the bottom ring 2, there is an opening 21, which exactly allows the support frame 3 to pass. Also, on both sides of the clip element 33, the bottom ring equips punched convex stoppers 212 to constrain the movement of the support frame 3. Finally, weld the opening on the bottom ring.

The support frame 3 comprises of dual vertical arch bars 31 and upper transversal arch bars 32, which match the curvature of the top ring. After the assembly of the upper transversal arch bar 32 on the support frame, the upper transversal arch bars 32 hit exactly the bottom rim of clip hooks 111 on the ends of the support bars 11 to constrain the movement of the support frame. The bottom of the support frame 3 is continuously punched to form flat clip elements 33. The continuously punching makes the clip elements 33 in round shape. Also, the center for each clip element 33 is punched to form piercing holes 331 and to allow the penetration of the bottom ring 2.

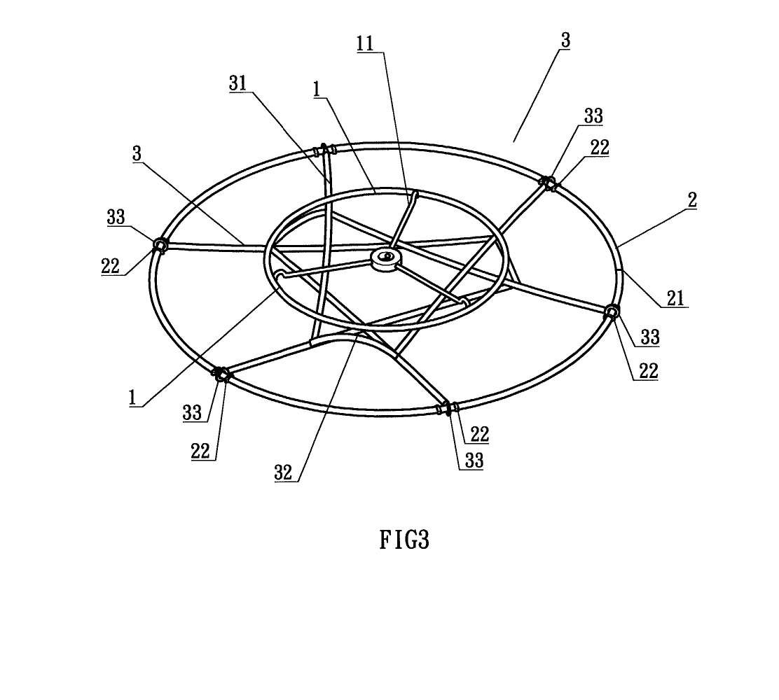

Please refer FIG. 3. The clip elements 33 on the support frame join the bottom ring 2 with arbitrary rotation, also, during the assembly of the lamp cover, the support frame 3 can be rotated downward to reach a horizontal state. The lamp cover can thus be assembled with minimum volume to achieve the objectives of easy assembly and to reduce storage volume and delivery cost.

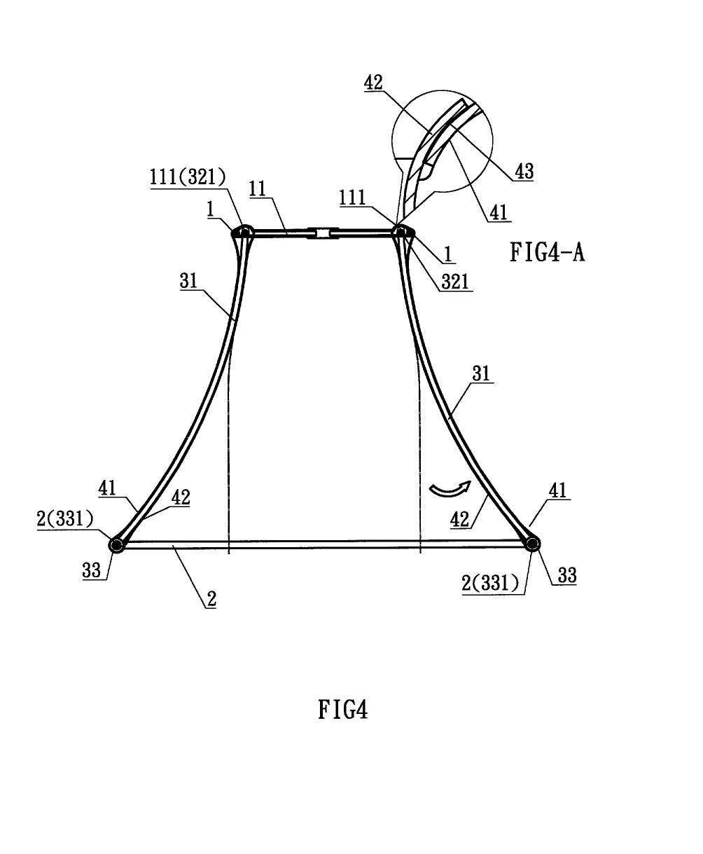

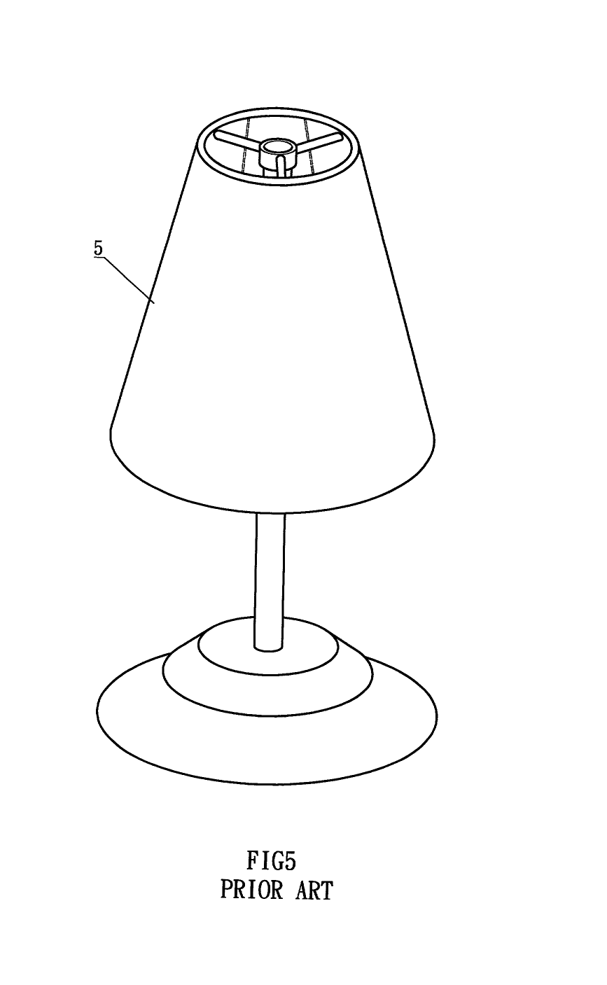

Please refer FIG. 4. After the assembly of frame base for the lamp cover, a cloth lamp cover 4 can be covered on the exterior area between the top ring 1 and the bottom ring 2. For the lamp cover 4, one may make the exterior cloth 41 tight in advance and fasten it on the rim of the support frame 3, then, lay an inner-layer cloth 42 on the interior of the support frame 3. On the appropriate locations, three are adhesion bandages 43 on the inner and external cloth to wrap the support frame. The frame is not exposed and the structure of combined cloth is formed for the effect of esthetics. The frame base can also be folded together with the lamp cover 4 to reduce storage volume and to decrease delivery cost.

The above explanation is a substantial embodiment of the invention, which provides greater practical performance and simplification than products of prior art. Furthermore, the present invention meets all new patent application requirements and is lawfully submitted for review and the granting of the commensurate patent rights to thereby encourage the spirit of invention and its rightful protection under the patent law.

1. The invention, a kind of improved structure for separable lamp cover, mainly comprises of a top ring on the very top of the lamp cover, a bottom ring, of which the perimeter is greater than that of the top ring, and a support frame connecting the top ring and the bottom ring; furthermore, the top ring extrudes radiantly to form support bars, of which the end of the bars are bent upward as clip hooks, which fix the rim of the top ring; also, on the proper location of the bottom ring, there is an opening, which exactly allows the support frame to pass; moreover, on both sides of the clip element, the bottom ring equips punched convex stoppers to constrain the movement of the support frame and the opening on the bottom ring is welded; also, the support frame comprises of dual vertical arch bars and upper transversal arch bars, which exactly hit the bottom rim of clip hooks on the end of support bars to constrain the movement of the support frame; furthermore, on the bottom of the support frame, there are punched flat clip elements, of which the center are punched with piercing holes and both sides of the elements on the support frame are punched with flat convex stoppers to match the bottom ring; thus, the lamp cover can be assembled with minimum volume to achieve the objectives of easy assembly and to reduce storage volume and delivery cost.

2. As mentioned in claim 1 of a kind of improved structure for separable lamp cover, a cloth lamp cover can be covered on the exterior area between the top ring and the bottom ring and for the lamp cover, one may make the exterior cloth tight in advance and fasten it onto the rim of the support frame; then, lay an inner-layer cloth on the interior of the support frame and on the appropriate locations, three are adhesion bandages on the inner and external cloth to wrap the support frame; thus, the frame is not exposed and the structure of combined cloth is formed for the effect of esthetics and the frame base can also be folded together with the lamp cover to reduce storage volume and delivery cost.
